(19) United States
(12) Patent Application Publication
(10) Pub. No.: US 2009/0272548 A1
(43) Pub. Date: Nov. 5, 2009

(54) WATER PUMP ASSEMBLY

(76) Inventor: David W. Moynihan, Ellicott City, MD (US)

Correspondence Address: HARNESS, DICKEY & PIERCE, P.L.C., P.O. BOX 828, BLOOMFIELD HILLS, MI, 48303, US

(21) Appl. No.: 12/464,076

(22) Filed: May 11, 2009

Related U.S. Application Data
(63) Continuation-in-part of application No. 11/449,843, filed on Jun. 8, 2006, now abandoned.
(60) Provisional application No. 60/688,412, filed on Jun. 8, 2005.

(51) Int. Cl. A62C 31/00; F04D 29/44; F04B 47/08; F04B 49/00; F04B 35/04

(52) U.S. Cl. 169/13; 415/206; 417/375; 417/53; 417/423.14

(57) ABSTRACT

A portable, fully submersible, high volume water pump, driven by a hydraulic powered motor is disclosed for rapidly supplying a large volume of water at useable pressures to an extinguishment operation involving a burning object or building, utilizing a local water source such as a pond, pool, portable basin, or municipal hydrant. The pump is fully portable and, in a preferred embodiment, used in conjunction with an extensible boom arm of a utility vehicle such as a fire engine. The pump can supply water from a source having as little as two inches of water depth and is simple in design and manufacturability.

### CROSS-REFERENCE TO RELATED APPLICATIONS

This application claims the benefit of U.S. Provisional Application No. 60/688,412, filed on Jun. 8, 2005, U.S. Non-Provisional application Ser. Nos. 11/449,843, filed on Jun. 8, 2006 and 12/221,250, filed Jul. 31, 2008. The disclosures of the above applications are incorporated herein by reference.

### FIELD OF THE INVENTION

The present invention relates to water pump assemblies. More particularly, this invention relates to a portable high volume water pump assembly for use in fire fighting operations.

### BACKGROUND OF THE INVENTION

In emergency situations, such as when a building, vehicle or other large object catches fire, a matter of seconds determines not only whether the object is a total loss, but whether lives could be at risk. It is therefore imperative that personnel trained to put out the fire arrive on the scene as quickly as possible. Furthermore, they must be provided with the proper extinguishing supplies with which they use to sequester the fire, such as water. Many rural and even urbanized areas of the world are not outfitted with a constant supply of pressurize water with the dedicated purpose of extinguishing fires such as fire hydrants.

Alternative sources therefore must often be used in order to battle many of these fires. One such example is a mobile tank mounted on a vehicle such as a fire engine for supplying the water. Unfortunately, these carry a very limited volume in which they can transport, are not always available in every community, and therefore may not provide the amount of water necessary to fully put out a large fire. Local sources of water such as swimming pools, ponds, or lakes have the potential to be a great source of water for fighting fires, but providing a means of getting the water out of the pool or pond and onto the fire in the very swift manner and in sufficient volume necessary to salvage the burning object proves difficult. Therefore it would be advantageous to have a portable and submersible means of pumping the water out of theses sources which can quickly be implemented in an emergency situation, and provide the fire fighters with a supply of water having high enough pressure and volume to quickly tend to the fire.

### SUMMARY OF THE INVENTION

It is therefore an object of the present invention to provide a portable, hydraulically powered water pump useable for situations such as fire fighting and industrial dewatering.

Another object of the present invention is to provide a portable pump that is used in conjunction with a boom arm of a utility or firefighting vehicle, for placing the pump in a supply of water some distance away from the vehicle.

Another object of the present invention is to provide a portable high volume water pump which can be utilized in a water source such as a pond, pool, or on municipal pressure hydrants to boost output pressure.

Still, a further object of the present invention is to provide a portable, high volume pump which may be utilized in a water source having as little as two inches of water depth.

It is a further object to provide a pump that is simple in design and manufacturability and can be utilized in a plurality of applications.

These and other objects will be understood wherein the present invention discloses a portable, fully submersible high volume water pump, driven by a hydraulic powered motor, for rapidly supplying a large volume of water to an extinguishment operation involving a burning object or building, from a local water source such as a pond, pool, portable basin or municipal hydrant. The pump is fully portable and protected within an attached housing. In a preferred embodiment, it may be used in conjunction with an extensible boom arm of a utility vehicle such as a fire engine or other utility truck. The water pump is run from a vehicle mounted or portable pressure compensated load sensing hydraulic system, allowing for variable flow and pressure, and can supply water from a source having as little as two inches of water depth. The volume of water deliverable from the present invention is comparable to that delivered from a fire engine pump itself and may be utilized to directly extinguish or refill a supply of water on a vehicle for subsequent use.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a perspective view of the preferred embodiment comprising the water pump, coupler, and hydraulic motor assembly;

FIG. 2 is a side view of the assembly shown in FIG. 1;

FIG. 3 shows an end view of the water pump assembly comprising the intake strainer and discharge tube;

FIG. 4 illustrates a cross sectional view of the coupler assembly with splined drive shaft of the present invention taken along line 4 of FIG. 2;

FIG. 5 illustrates a side, phantom view of the water pump assembly within the pump housing body; and

FIG. 6 is a partial side-view of the pump assembly in combination with a boom of a utility vehicle.

### DETAILED DESCRIPTION OF THE PREFERRED EMBODIMENTS

The following description of the preferred embodiment(s) is merely exemplary in nature and is in no way intended to limit the invention, its application, or uses.

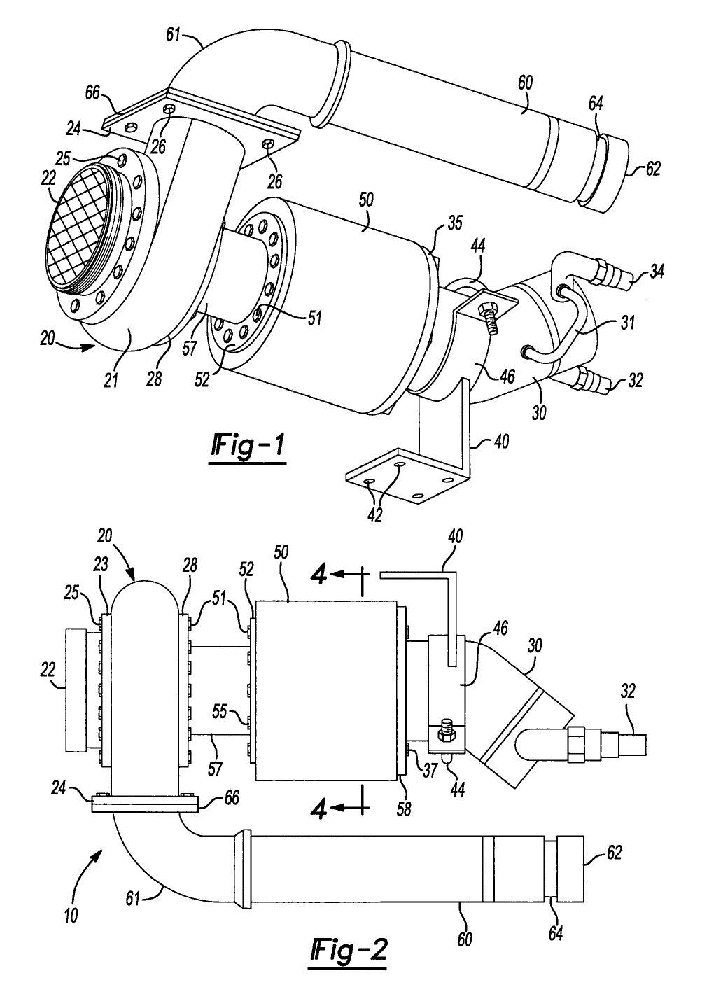

Referring now to the figures, in particular FIGS. 1 and 2, a preferred embodiment of the water pump assembly 10 is shown comprising the main elements of a water pump 20, hydraulic motor assembly 30, and coupler 50 disposed therebetween. In an exemplary embodiment of this invention, a high volume, high pressure pump assembly 10 is disclosed herein. Water pump 20 can be any commercially available pump that is operable to deliver high volumes of water at high pressures, i.e. at least 200 L/min and at pressures greater than 100 kPa (14.5 psi), generally ranging from 100 kPa (14.5 psi) to about 2100 kPa (305 psi). In exemplary embodiments, water pump 20 can include, any rotary non-positive displacement pump. In some embodiments, the pump can be a centrifugal pump, a boundary layer pump, a disc pump and turbine pumps. In some preferred embodiments, the water pump 20 is a centrifugal pump.

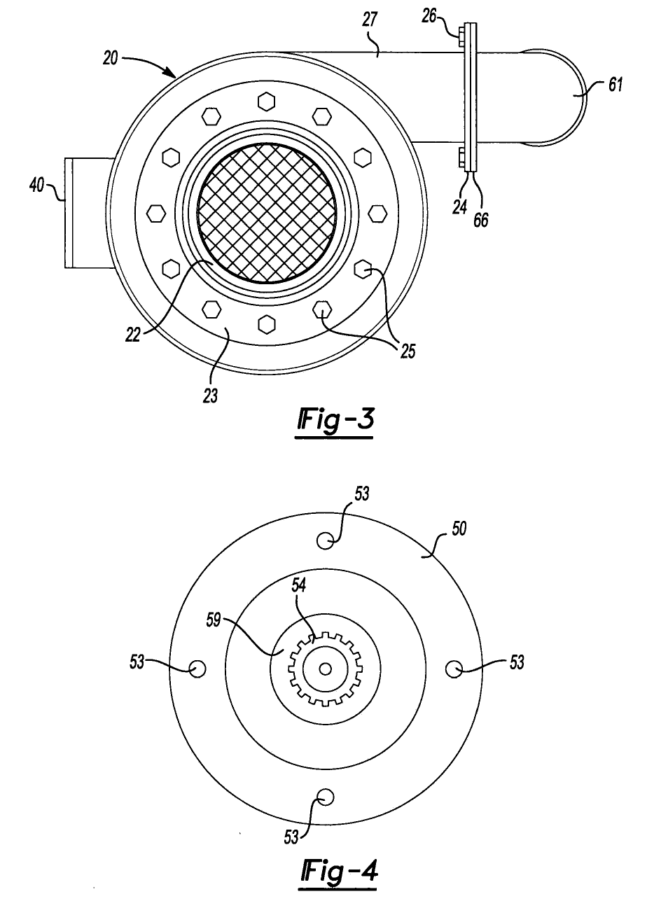

Water pump 20 (also shown in FIG. 3 for clarification purposes) comprises a pump housing 21, containing the high volume impeller rotatably supported therein. An intake screen 22 is attached to the bottom side of the housing by a plurality of fasteners 25 bolted through evenly spaced apertures in the intake flange 23 surrounding intake screen 22. The screen prevents large foreign materials from being drawn into the pump impeller during operation which could possibly cause damage to pump assembly 10.

In some embodiments, the pump assembly 10 described herein is capable of discharging water at high volumes at high pressures. Commercially available water pumps for pumping fluids, for example water can deliver high volumes, but this is sacrificed for low pressure. The present disclosure provides advantages related to high volume and high-pressure pumps operable to deliver volumes ranging from about 10,000 L/per minute (L/min) to about 200 (L/min), from about 5,000 (L/min) to about 200 (L/min), from about 2000 (L/min) to about 200 (L/min), from about 1000 (L/min) to about 200 (L/min) or from about 500 (L/min) to about 200 (L/min), or from about 10,000 L/per minute (L/min) to about 500 (L/min), from about 10,000 (L/min) to about 1000 (L/min), from about 10,000 (L/min) to about 2000 (L/min), from about 10,000 (L/min) to about 5,000 (L/min) or from about 10,000 (L/min) to about 7,500 (L/min) In some embodiments, the volume of water discharged can be at least 10,000 (L/min), or at least 7,500 (L/min), or at least 5,000 (L/min), or at least 1,000 (L/min), or at least 500 (L/min), or at least 200 (L/min).

The operating volumes delivered by the pump assembly 10 of the present disclosure can operate at specific pressures designated by the user and in some embodiments meet and/or exceed fire service performance. The water pump of the present disclosure provides advantages that are not met in other portable, for example, truck mounted high water volume pumping systems, as these lack the sufficient pressure delivery required for fire rescue applications. In some embodiments, the operating pressures used to deliver the volumes of water described above can range from about 100 kPa (14.5 psi) to about 2100 kPa (305 psi), or from about 200 kPa (29 psi) to about 2100 kPa (305 psi), or from about 500 kPa (73 psi) to about 2100 kPa (305 psi), or from about 750 kPa (109 psi) to about 2100 kPa (305 psi), or from about 1000 kPa (145 psi) to about 2100 kPa (305 psi), or from about 1500 kPa (218 psi) to about 2100 kPa (305 psi).

In some embodiments, pump housing 21 further comprises a tangential pump output 27, which terminates in a flange plate 24 attached to a discharge elbow 61 having a complementary flange plate 66, by means of fasteners 26 positioned through the two plates 24 and 66.

Opposite intake screen 22 on pump 20, housing 21 attaches to the drive shaft housing 57, by means of the shaft housing flange 28 and mounting hardware 51. Referring now to FIGS. 1 through 4, coupler shaft housing 57 surrounds and supports the splined impeller shaft 54 and attaches to coupler 50 opposite the water pump by flange 52. The splined shaft coupler 50 is supported by ball bearings (not shown) seated in coupler shaft housing 57 to allow rotational force to be transmitted from hydraulic motor assembly 30 to pump 20. Coupler 50 has a throughbore 59 which contains and supports the union of splined impeller shaft 54 with the output shaft of hydraulic motor assembly 30, not shown. In other embodiments hydraulic motor assembly 30 can be interchanged with an electric motor, not shown. In some embodiments, hydraulic motor assembly 30 can be a bent-axis motor. In some embodiments, the bent-axis motor can include a VOAC F11 Series 19 bent-axis motor rated as having a displacement of 19 cm³/rev and a maximum continuous speed of about 8100 rpm and 3500 rpm self-priming speed at the oil providing approximately 50 horsepower. The VOAC/Parker F11 Series 19 bent-axis motor is commercially available from Parker Hannifin, (Trolhättan, SE). As mentioned, coupler 50 comprises a cylindrical housing, attaching at a lower end 55 to water pump shaft housing 57 and at an upper end 58 to the hydraulic motor assembly flange 35 through mounting apertures 53 in coupler 50 threadably receiving mounting hardware 37. Coupler 50 can include a Hydraulic motor assembly 30, receives a pressurized supply of hydraulic fluid which enters the pump through attached fluid input 32 and discharges through output 34 to the supply container through hydraulic lines. Hydraulic motor assembly 30 can be connected to a flush faced no drip quick coupling system to facilitate swift deployment of said pump 20 in an emergency situation. These flushed face quick coupling devices are commercially available from Dixon Valve and Coupling, (Chestertown, Md., USA) for example an HT Series ISO 16028, Flush Face Coupler, Part No 6HTF8-SS. ISO FF Coupler

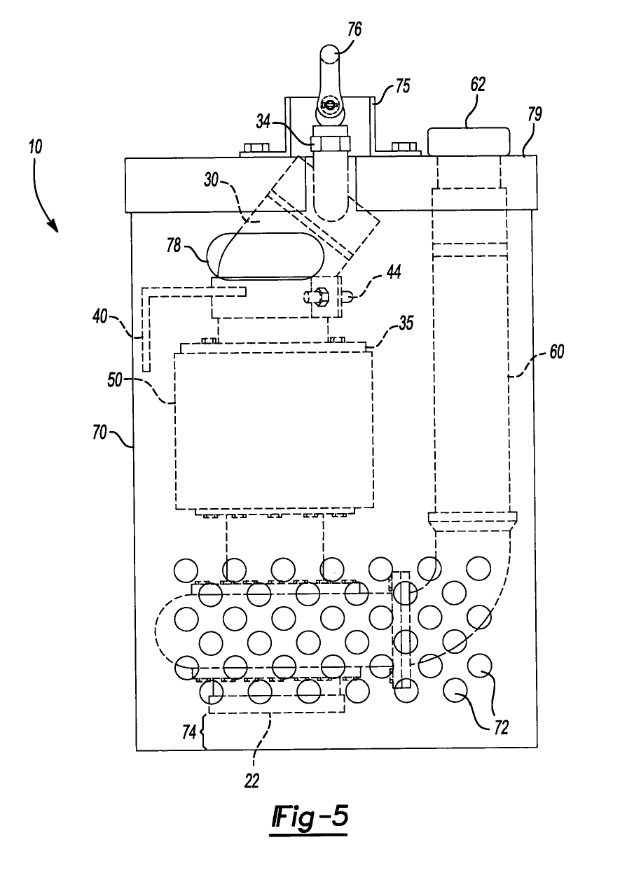

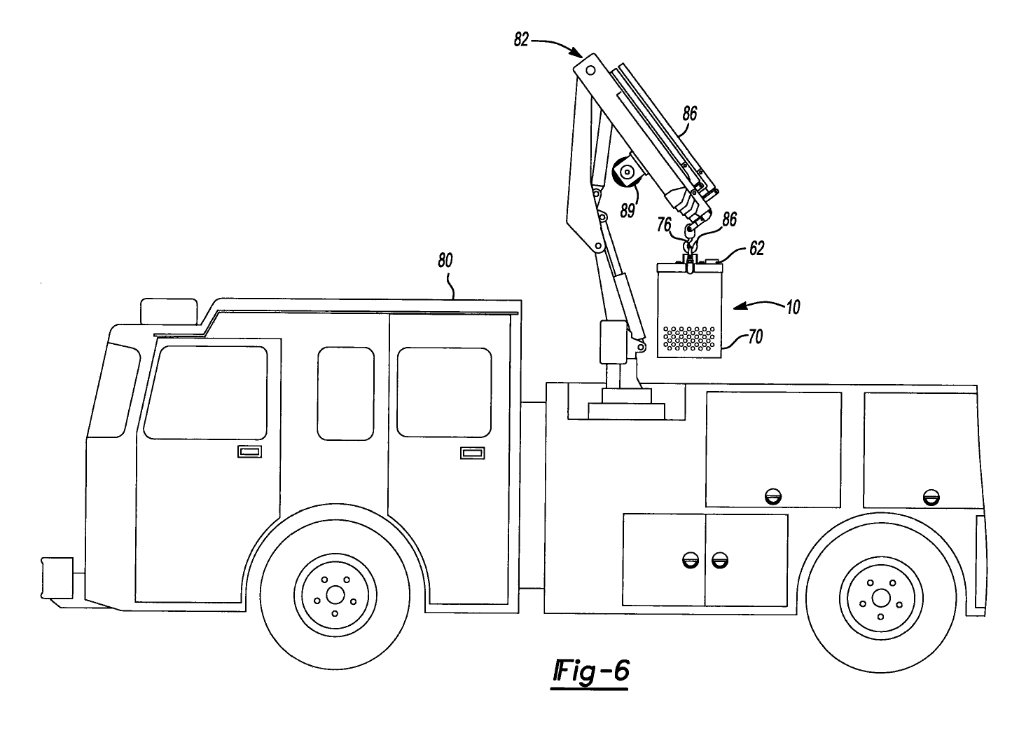

These lines, not shown, can optionally be stored on a reel mechanism for simplified disbursement and retraction while pump assembly 10 is being utilized. A hydraulic motor case drain 31 is connected between motor 30 and the hydraulic fluid output 34 in a venturi arrangement preventing a buildup of excess case pressures. The hydraulic fluid is supplied from a source mounted upon the vehicle or power unit used for implementing the pump. Attached to the body of hydraulic motor 30 is a mounting element 40, secured by means of a support collar 46 and threaded U-bolt 44. Mounting element 40, comprising an L-shaped mounting bracket, has a plurality of housing attachment apertures 42 therein for attaching pump assembly 10 within the pump housing 70 as shown in FIGS. 5 and 6.

Housing 70, manufactured from aluminum, steel, or other suitable material, comprises a rectangular container which protects pump assembly 10 from damage during transportation and storage and further provides protection of pump assembly 10 from large foreign matter entering the pump impeller and causing damage while in use. This is accomplished by providing housing 70 with a series of apertures 72 through which the water must flow into prior to being drawn into intake screen 22 of pump 20 located therein. Apertures 72 are numerous enough not to impede the pump's performance and supply delivery and are positioned low enough on housing 70 so as to allow the pump assembly to operate in as little as two inches of water as shown by numeral 74. One or more access apertures 78 may be positioned higher up on the housing for accessing the hydraulic pump or lines for maintenance or replacement.

As previously disclosed herein, pump housing 21 attaches to discharge elbow 61 which in turn is attached to a discharge pipe 60 running vertically up and out of the pump housing 21, parallel to pump assembly 10. Discharge pipe 60 terminates at an upper end 62 through the top side 79 of housing 70 and has a hose connector means 64 for sealably connecting to a flexible hose such as those of woven textiles. Upper end 62 of housing 70 further comprises a mounting plate 75, which receives a clevis-type shackle 76 therethrough for hanging assembly 10 from a boom-style utility arm 82 as shown in FIG. 6.

The boom arm 82, shown attached to a utility vehicle 80, comprises a series of extensible members 86 which allow for the precise extension and positioning of the pump near the side in the preferred aspect of the final side. Therefore it is allowable to include the same therewith in incorporation pump assembly 10 over a source of water away from the vehicle such as a pond, swimming pool, portable basin, or municipal hydrant. With boom arm 82 extended over the source of water, the hook 84, holding pump assembly 10 by shackle 76, is lowered by a cable winch 89 until it is submerged to a point below intake apertures 72 located in the housing. The entire assembly can be fully submerged, with no loss of performance, and preferably should be lowered into the source as much as possible to assist in pump cooling and to avoid drawing in air that may cause the pump to cavitate and/or decrease the output pressure and volume. Once the supply of water needed has been furnished, hydraulic motor 30 is shut off from vehicle 80, or power unit, and cable winch 89 and boom arm 82 retract pump assembly 10 back to vehicle 80.

In an alternative embodiment, intake flange 23 of the present invention provides a further means for connecting assembly 10 to the discharge of a municipal hydrant so as to provide increased pressure therefrom, if desired.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A portable water pump assembly for pumping fluids comprising:
(a) a water pump disposed within a pump housing, said water pump comprising a rotatable impeller and an impeller housing containing said impeller;
(b) a motor assembly connected to said coupler;
(c) a coupling means having a throughbore disposed between said water pump and said motor assembly and detachably attached to said water pump; and
wherein said coupler is adapted to house an impeller shaft operatively connected to an output shaft in said motor assembly; said motor assembly connected to a power supply line and wherein said water pump is configured to enable delivery of water through a discharge pipe at volumes ranging from about 200 L/min to about 10,000 L/min at operating pressures ranging from about 100 kPa to about 2100 kPa.

2. The portable water pump assembly of claim 1, wherein said impeller housing has an axial intake and a tangential discharge, said discharge is attached to a discharge pipe passing through said pump housing to the outside, and having a coupling means disposed on the exterior end for detachably attaching to a hose.

3. The portable water pump assembly of claim 2, wherein said intake of said impeller housing has an intake screen and is positioned proximal a bottom side of said pump housing, said pump housing having a plurality of apertures through which fluid is drawn into said housing and said water pump.

4. The portable water pump assembly of claim 3, wherein the intake screen is positioned within said pump housing so as to allow said centrifugal pump to draw in fluid from a volume of fluid having a depth of at least two inches.

5. The portable water pump assembly of claim 1, wherein said pump housing comprises a means of attaching said water pump assembly to an extendable boom arm attached to a vehicle, allowing the lowering of said pump assembly into a volume of fluid, such as water, proximate said vehicle.

6. The portable water pump assembly of claim 1, wherein said motor assembly is powered by an electrical power system.

7. The portable water pump assembly of claim 1, wherein said motor assembly is powered by a pressure compensated load sensing hydraulic system.

8. The portable water pump assembly of claim 7, wherein said hydraulic system is attached to a vehicle having a boom arm.

9. The portable water pump assembly of claim 1, wherein said housing is manufactured from steel.

10. The portable water pump assembly of claim 1, wherein said housing is manufactured from aluminum alloy.

11. The portable water pump assembly of claim 1, wherein said water pump comprises a centrifugal pump, a gear pump, a piston pump or a vein pump.

12. A portable water pump assembly for pumping fluids comprising:
(a) a centrifugal pump having a rotatable impeller disposed within an impeller housing;
(b) a motor assembly said motor being powered by a pressure compensated load sensing hydraulic system attached to a vehicle;
(c) a coupling means having a throughbore disposed between said centrifugal pump and said motor assembly and detachably attached to said centrifugal pump; and
(d) a power supply adapted to provide power to said motor assembly; and
(e) a pump housing having an inner volume wherein said centrifugal pump, motor assembly and coupling means are contained within and detachably attached thereto, said motor assembly being detachably attached to said coupling means, and provides a rotatable force which is transferred through said coupling means by means of a splined drive shaft to said centrifugal pump impeller, which is couplingly attached to said splined drive shaft, said impeller housing having an axial intake and a tangential discharge, said discharge being journally attached to a discharge pipe passing through said housing to the outside, and having a coupling means disposed on the exterior end for detachably attaching to a hose, said intake of said impeller housing having an intake screen, positioned proximal a bottom side of said pump housing, said housing having a plurality of apertures through which fluid is drawn into said housing and said centrifugal pump from a volume of fluid having a depth of at least two inches, said pump housing further comprising a means of attaching said water pump assembly to an extendable boom arm attached to said vehicle, allowing the lowering of said pump assembly into a volume of fluid, such as water, proximate said vehicle, wherein said centrifugal pump is coupled to said motor assembly to enable delivery of water through a discharge pipe at volumes ranging from about 200 L/min to about 10,000 L/min at operating pressures ranging from about 500 kPa to about 2100 kPa.

13. The portable water pump assembly of claim 12, wherein said motor assembly comprises an electric motor assembly or a hydraulic motor assembly.

14. The portable water pump assembly of claim 13, wherein said hydraulic motor assembly is connected to a hydraulic fluid supply line pressurized with hydraulic fluid.

15. The portable water pump assembly of claim 14, wherein said hydraulic motor assembly is operably connected to a hydraulic input, wherein said hydraulic input is adapted to be mated with a hydraulic hose reel for remote operation.

16. The portable water pump assembly of claim 15, wherein said hydraulic motor assembly further comprises a motor case drain connected between said motor assembly and a hydraulic fluid output, said motor case drain being configured in a venturi arrangement.

17. A method of delivering a rapid supply of water from a remote source comprising utilizing the portable water pump assembly of claim 10 stored on a vehicle and attached to a extendable boom arm of said vehicle by:
(a) maneuvering said vehicle proximate a source of water from the following list comprising a swimming pool, a pond, a stream, a lake, portable basin;
(b) attaching a predetermined length of hose to said discharge of said pump;
(c) extending said boom arm over said source of water and lowering said pump assembly into said water; and
(d) engaging said hydraulic system so as to provide power to said pump assembly, thereby drawing water from said intake of said impeller housing and discharging it through said hose at a flow rate ranging from about 200 L/min to about 10,000 L/min at operating pressures ranging from about 100 kPa to about 2100 kPa.
